(19) United States
(12) Patent Application Publication
(10) Pub. No.: US 2024/0338950 A1
(43) Pub. Date: Oct. 10, 2024

(54) SYSTEMS AND METHODS FOR SENSING ENVIRONMENT AROUND VEHICLES

(71) Applicant: VAYYAR IMAGING LTD., Yehud (IL)

(72) Inventors: Alon KEREN, Tel Aviv (IL); Noam WAGNER, Herzliya (IL); Tom HAREL, Shefayim (IL); Mark POPOV, Ramat Gan (IL)

(21) Appl. No.: 18/579,353

(22) PCT Filed: Jul. 13, 2022
(86) PCT No.: PCT/IB2022/056459

§ 371 Date: Jan. 14, 2024

Related U.S. Application Data
(63) Continuation-in-part of application No. 18/135,784, filed on Apr. 18, 2023.
(63) Continuation of application No. 17/775,325, filed on May 9, 2022, now Pat. No. 11,663,833.
(60) Provisional application No. 63/221,963, filed on Jul. 15, 2021.
(60) Provisional application No. 63/230,755, filed on Aug. 8, 2021.
(60) Provisional application No. 63/284,057, filed on Nov. 30, 2021.
(60) Provisional application No. 63/037,026, filed on Jun. 10, 2020.
(60) Provisional application No. 63/037,021, filed on Jun. 10, 2020.
(60) Provisional application No. 62/955,487, filed on Dec. 31, 2019.
(60) Provisional application No. 62/932,511, filed on Nov. 8, 2019.

(51) Int. Cl. G06V 20/58; B60W 40/105

(52) U.S. Cl. CPC G06V 20/58; B60W 40/105; B60W 2420/408; B60W 2554/4049

(57) ABSTRACT

Systems and methods for detecting angle of a vehicle using a radar including an array of transmitters, transmitting electromagnetic radiation towards surrounding objects, and receivers detecting reflected electromagnetic signals. Received information includes horizontal coordinates and vertical coordinates for each object detected. A pre-processing unit determines stationary and non-stationary state of objects from the received electromagnetic signals. A processing unit receives the coordinates along with motion characteristics of objects and plots each reflected object in the horizontal-vertical plane perpendicular to the direction of motion of the vehicle. A virtual box is constructed corresponding to each of a series of candidate tilt or roll angles. The angle of the virtual box having the largest number of plotted reflections is selected as the angle of the vehicle.

### CROSS-REFERENCE TO RELATED APPLICATIONS

This application claims the benefit of priority from U.S. Provisional Patent Application No. 63/221,963, filed Jul. 15, 2021, U.S. Provisional Patent Application No. 63/230,755, filed Aug. 8, 2021, and U.S. Provisional Patent Application No. 63/284,057, filed Nov. 30, 2021 the contents of which are incorporated by reference in their entirety.

### FIELD OF THE INVENTION

The disclosure herein relates to systems and methods for using radars to sense the environment around vehicles. In particular, systems and methods are described for detecting the tilt of vehicles and for providing audio alerts to indicate presence and direction of objects detected in the vehicle's environment.

### BACKGROUND OF THE INVENTION

Various sensors may be used to sense objects. Indeed with the increased usage of autonomous vehicles such as self-driving cars and the like a plethora of sensors are used to detect objects in the vicinity of travelling vehicles. For example, sensors such as video cameras, ultrasonic sensors, infrared, LIDAR sensors and the like may be used to provide information pertaining to the environment through which the vehicle is travelling.

The application of radar is becoming more and more popular with the development of the RFIC and signal technology. Radar sensors have the advantage of operating in total darkness, fog, mist and rain. Radar is an electronic system with the advantages of low cost, low-power consumption, and high precision. It can be significantly applied in various applications including, space shuttle topographic missions, optics, geotechnical mapping, meteorological detection, and so on. The working efficiency of a radar system is based upon reliable and stable radar signal with wide coverage, high directionality, high gain and low signal-to-noise ratio.

Two-wheeler vehicles are provided with various active driving assist devices which actively assist the drivers. These include various sensors, brake system, engine management system, and HMI (Human Machine Interface). These sensors and systems act as a sensory organ enabling advanced motorcycle assistance and safety functions while providing an accurate picture of the vehicle's surroundings. As a result, these assistance functions not only increase safety, but also enhance enjoyment and convenience by making life easier for riders.

The sensors used may be radar-based sensors providing advanced rider assistance systems. The radar-based sensors may include an Adaptive Cruise Control (ACC) which adjusts the vehicle speed to the flow of traffic and maintains the necessary safe following distance. Another radar-based sensor is a Forward Collision Warning System which detects when another vehicle is dangerously close and warns the rider by way of an acoustic or an optical signal. The radar-based Blind-spot Detection keeps a lookout in all directions to help motorcyclists change lanes safely. All of these and other safety systems protect the rider from collision with the nearby vehicles or objects.

The motorcycle riders often tilt or lean to a side while riding, especially during turns. The leaning of the motorcycle creates a big risk to the rider. The risk is enhanced when the plane of the road is not horizontal, like on a hill. The abnormal leaning of the vehicle during riding is a major cause of accidents for two-wheeler vehicles. Proper presentation of the radar image to the driver may depend on the tilt angle. Assessment of hazard posed by objects detected by the radar may depend on the tilt angle as well. Thus, there is a need for a system which accurately detects the leaning or tilt angle of the road and the vehicle and generate necessary outputs.

Furthermore, it is important to provide drivers with useful information regarding hazards surrounding the vehicle. However, it has been found that visual alerts presented to a driver indicating surrounding hazards may themselves become hazardous distractions. The need remains for a system for presenting such hazards to drivers in a natural and non-distracting manner.

The invention described herein addresses the above-described needs.

### SUMMARY OF THE EMBODIMENTS

In one aspect of the invention, a system for detecting the tilt of a two-wheeler vehicle such as a motorcycle using a mounted radar system is disclosed. The system includes a radar-based sensor unit, a processing unit, a database and a communicator.

In another aspect of the invention, the radar-based sensor unit may include an array of transmitters and receivers which are configured to transmit a beam of electromagnetic radiations towards the objects on the road on which the motorcycle is being driven and receive the electromagnetic waves reflected by objects, respectively. The information received by the receiver may include a horizontal coordinate (perpendicular to the direction of travel or the vehicle) and a vertical coordinate for each object detected. The sensor unit may also include a pre-processing unit which comprises a motion characteristic extraction module for determining the stationary and non-stationary state of the objects from the received electromagnetic signals. The processing unit receives the horizontal and vertical coordinates along with the motion characteristics of the objects and plots a two-dimensional coordinate of each reflected object in the horizontal-vertical plane perpendicular to the direction of motion of the vehicle. The processing unit is further configured to select a series of candidate tilt or roll angles and constructs a rectangular box corresponding to each roll angle. The processing unit is also configured to count the number of reflections plotted inside each rectangular box and selects the tilt angle having the maximum number of plotted points inside the box as the tilt angle of the vehicle.

In a further aspect of the invention, the tilt angle of the vehicle at different instances of time may be calculated and stored in the database. The communicator may then transmit the tilt angle of the vehicle and the corresponding notification to the concerned parties through a communication network.

According to still other aspects of the invention, a method is taught for determining the roll of a moving object by providing a vehicle mounted radar unit comprising a radar transmission unit comprising an array of transmitter antennas connected to an oscillator, and a radar receiving unit comprising at least one receiver antenna, providing a processing unit in communication with the radar receiving unit, transmitting electromagnetic radiation into the region surrounding the vehicle, receiving electromagnetic radiation reflected from objects in the region surrounding the vehicle, transferring received electromagnetic signals to the processing unit, plotting the two-dimensional coordinates of each reflected object in the horizontal-vertical plane perpendicular to the direction of motion of the vehicle, and selecting a series of candidate tilt angles. For each candidate tilt angle, constructing a virtual box parallel to an associated candidate horizon, and counting reflections within the virtual box, then selecting the candidate tilt angle with largest number of reflections within the virtual box.

Optionally, the virtual box comprises a rectangular box. For example, a box extending from 20 centimeters below candidate ground level to 2 meters above candidate ground level.

### BRIEF DESCRIPTION OF THE FIGURES

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the various selected embodiments may be put into practice. In the accompanying drawings:

FIG. 1 illustrates a schematic representation of a radar-based system 100 for measuring the tilt angle of a motorcycle according to an aspect of the invention;

FIG. 2 illustrates a schematic representation of a motorcycle equipped with a radar-based sensor;

FIG. 3 illustrates roll estimation method on a radar coordinate system;

FIG. 4 illustrates a flowchart showing method steps for measuring the tilt angle of a motorcycle according to an aspect of the invention;

FIG. 5 illustrates a 2D graphical representation of the signal reflected from objects on the road;

FIGS. 6A, 6B and 6C illustrate graphical representations of the reflected signals in the rectangular box for various candidate tilt angles;

FIG. 7A illustrates a travelling motorcycle receiving reflected signals from surrounding objects on an onboard radar oriented away from the direction of travel;

FIG. 7B is a typical clutter Doppler distribution profile; and

FIG. 7C illustrates the misalignment between between the direction of the motorcycle's front point and radar's boresight.

FIG. 8 is a block diagram indicating some key features of a system for providing directional audio alerts;

FIG. 9 schematically represents a vehicle mounted radar unit configured to sense objects in the region surrounding a vehicle;

FIG. 10 is a block diagram of selected elements of a possible radar system which may be provided for sensing the surroundings; and

FIG. 11, schematically represents an example of a vehicle cabin within which a set of audio signal generators are provided.

### DESCRIPTION OF THE SELECTED EMBODIMENTS

Aspects of the present disclosure relate to systems and methods for using radars to sense the environment around vehicles. In particular, systems and methods are described for detecting the tilt of vehicles and for providing audio alerts to indicate presence and direction of objects detected in the vehicle's environment.

The tilt of a two-wheeler vehicle such as a motorcycle may be detected using a mounted radar system for receiving electromagnetic signals reflected from the objects on the road and processing the electromagnetic signals to determine the tilt angle of the vehicle. The identified tilt angle may be sent to the concerned parties.

Other aspects of the present disclosure relate to providing sensory indications to drivers regarding detected objects surrounding their vehicles and alerting them to potential hazards without distracting them from their driving. In particular an audio signal generation unit may be configured to produce sounds such that a listener perceives the source of the sound as originated from the direction of the detected object.

As required, the detailed embodiments of the present invention are disclosed herein; however, it is to be understood that the disclosed embodiments are merely examples of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

As appropriate, in various embodiments of the disclosure, one or more tasks as described herein may be performed by a data processor, such as a computing platform or distributed computing system for executing a plurality of instructions. Optionally, the data processor includes or accesses a volatile memory for storing instructions, data or the like. Additionally or alternatively, the data processor may access a non-volatile storage, for example, a magnetic hard disk, flash-drive, removable media or the like, for storing instructions and/or data.

It is particularly noted that the systems and methods of the disclosure herein may not be limited in its application to the details of construction and the arrangement of the components or methods set forth in the description or illustrated in the drawings and examples. The systems and methods of the disclosure may be capable of other embodiments, or of being practiced and carried out in various ways and technologies.

Alternative methods and materials similar or equivalent to those described herein may be used in the practice or testing of embodiments of the disclosure. Nevertheless, particular methods and materials described herein for illustrative purposes only. The materials, methods, and examples not intended to be necessarily limiting. Accordingly, various embodiments may omit, substitute, or add various procedures or components as appropriate. For instance, the methods may be performed in an order different from described, and that various steps may be added, omitted or combined. In addition, aspects and components described with respect to certain embodiments may be combined in various other embodiments.

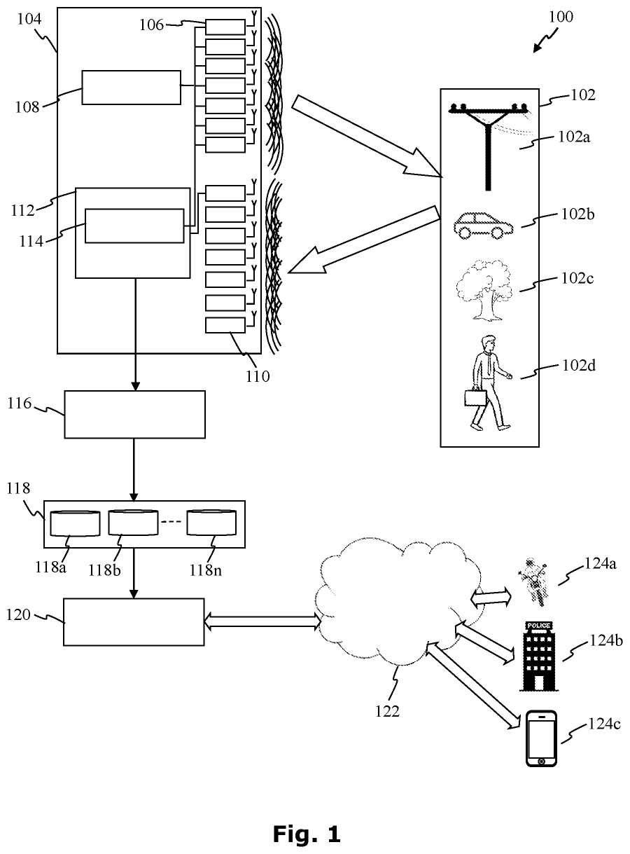

Reference is now made to FIG. 1, a schematic representation of a radar-based system 100 for measuring the tilt angle of a motorcycle according to an aspect of the invention. The system 100 includes a radar-based sensor unit 104, a processing unit 116, a database 118 and a communicator 120.

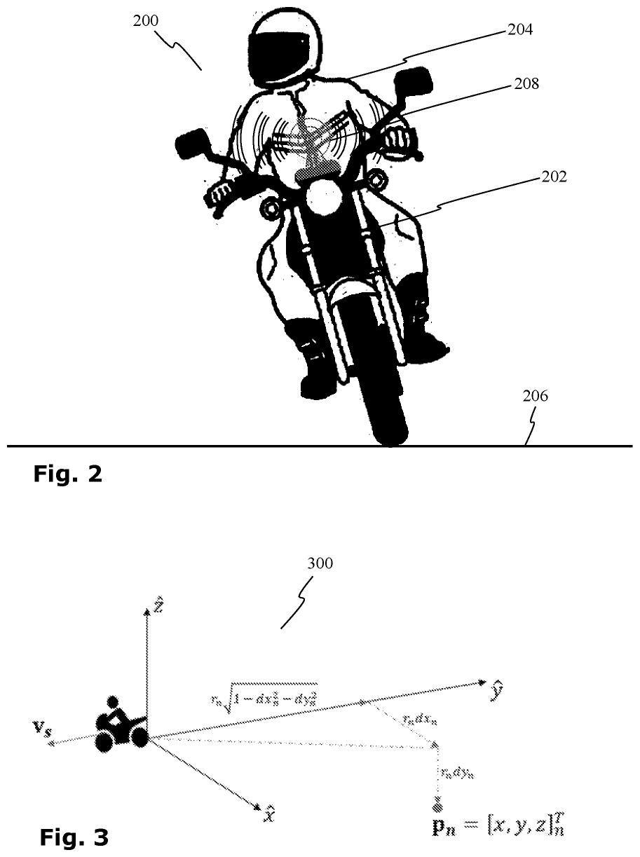

The radar-based sensor unit 104 may be mounted, for example, on a two-wheeler vehicle such as shown in FIG. 2 which illustrates a motorcycle 202 equipped with a radar-based sensor 208. The sensor 208 is shown to be mounted near the handle of the motorcycle 202. However, it should be noted that the sensor 208 may be mounted or attached to any part of the motorcycle 202 without limiting the scope of the invention. The motorcycle 202 is shown to be driven by a rider 204 who is riding the motorcycle 202 in a leaning position with respect to the horizon of a road 206. The sensor radar-based 208 transmits electromagnetic signals in all the directions while the motorcycle 202 is being driven.

Referring back to FIG. 1, the radar-based sensor unit 104 includes an array of transmitters 106 and an array of receivers 110. The array of transmitters 106 may include an oscillator 108 connected to at least one transmitter antenna or an array of transmitter antennas. Accordingly, the transmitters 106 may be configured to produce a beam of electromagnetic (EM) radiations, such as microwave radiation or the like, directed towards the objects on the road 102 on which the motorcycle 202 is being driven. The road 102 is shown to have stationary as well as non-stationary objects like a standing electricity pole 102a, a moving car 102b, a standing tree 102c and a moving man 102d. The road 102 may include a variety of other stationary and non-stationary objects, like sidewalls, animals, advertisement hoardings, bus stops, etc. towards which the EM signals may be sent. Further, the transmitter 106 may transmit the EM signals towards all directions on the road 102 surrounding the motorcycle 202.

The receiver 110 may include an array of receiver antennas configured and operable to receive electromagnetic waves reflected by objects on the road 102. The information received by the receiver 110 may include a horizontal coordinate (perpendicular to the direction of travel or the vehicle) and a vertical coordinate for each object detected. The information may also include the stationary and non-stationary state of the object including its state of walking, running, velocity, acceleration, etc.

The electromagnetic signals received by the receiver 110 are sent to a pre-processing unit 112 of the radar-based sensor unit 104. The pre-processing unit 112 comprises a motion characteristic extraction module 114 which is configured to determine the stationary and non-stationary state of the objects 102a, 102b, 102c and 102c from the received electromagnetic signals. The motion characteristics may also include, but not limited to, rate of acceleration and velocity, trajectory of the motion, the state of walking, running, and so on.

The horizontal and vertical coordinates along with the motion characteristics of the objects 102a, 102b, 102c and 102d generated by the module 114 are sent to the processing unit 116. The processing unit 116 is configured to plot two-dimensional coordinates of each reflected object 102a, 102b, 102c and 102d in the horizontal-vertical plane perpendicular to the direction of motion of the vehicle 202.

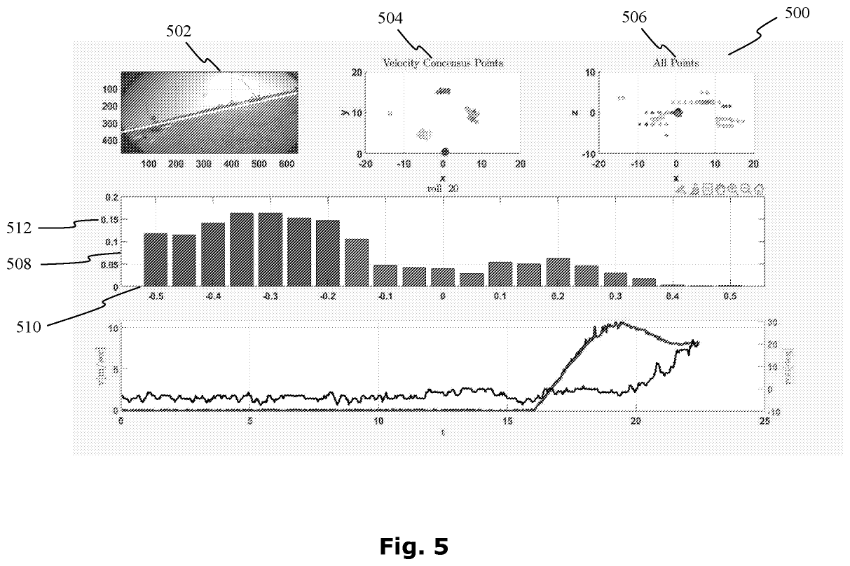

FIG. 5 illustrates a 2D graphical representation of the signal reflected from objects on the road 102. A camera reference 502 is shown with the horizon plotted based on the estimated roll or tilt. The Velocity Consensus Points 504 are the consensus set of “static points” projected on the XY plane. All the points 506 of all the stationary and non-stationary objects 102a, 102b, 102c and 102d are shown to be plotted on the XY plane. The graph 508 shows the plotting of roll estimation by the processing unit 116 along the x-axis 510 which is a measure of dx coordinate assumed for a unit vector, normal to the road, in radar coordinate system, and y-axis 512 which is a measure of per dx hypothesis (x axis) the percent of points located in resulting box.

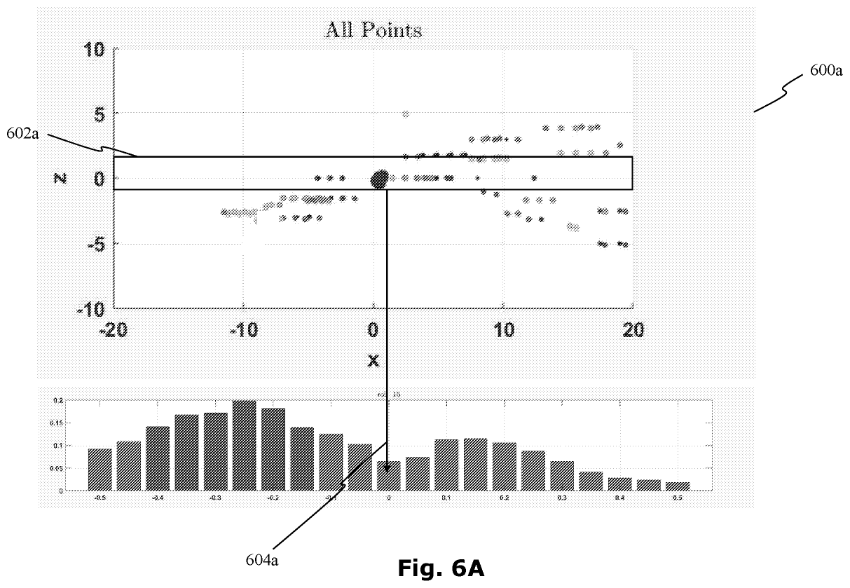

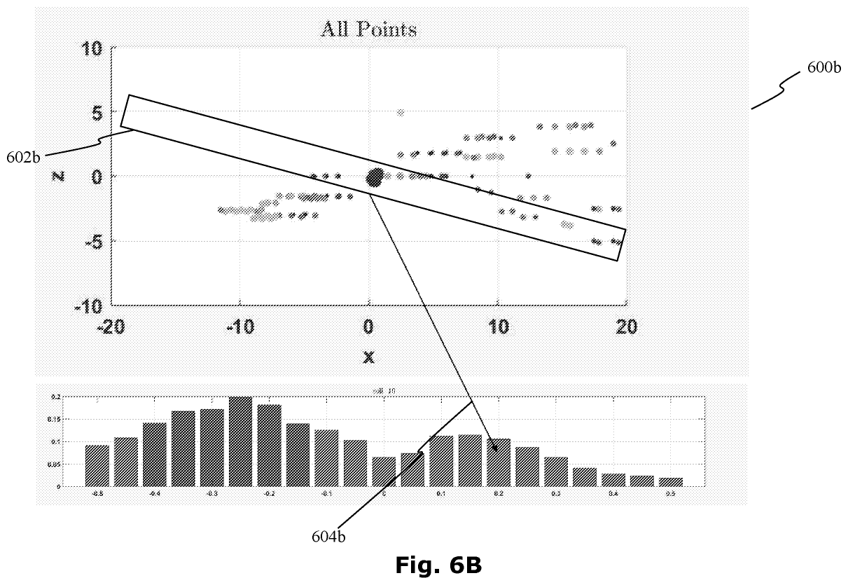

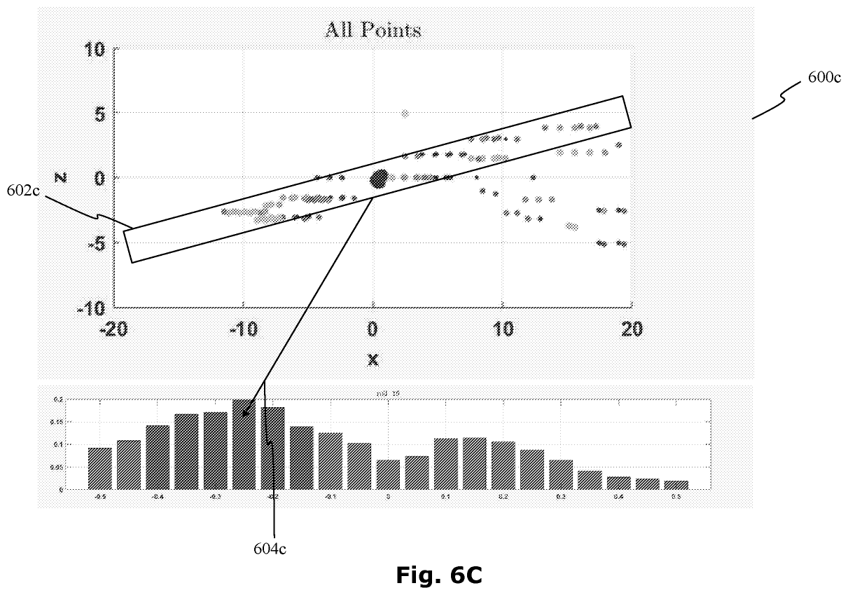

The processing unit 116 further selects a series of candidate tilt or roll angles based on the two-dimensional coordinates of the reflected objects 102a, 102b, 102c and 102d. For each candidate tilt angle, a rectangular box parallel to its horizon is constructed. FIGS. 6A, 6B and 6C illustrate exemplary rectangular boxes 602a, 602b and 602c constructed for different roll angles 604a, 604b and 604c, respectively. The number of reflections received from each object is plotted on the graphical representations 600a, 600b and 600c. The number of reflections plotted inside the rectangular boxes 602a, 602b and 602c are counted and the tilt angle having the maximum number of plotted points inside the box is selected as the tilt angle of the vehicle 202. FIG. 6C is shown to have the maximum number of points inside the box 602c and the corresponding roll angle 604c may be selected as the tilt angle of the vehicle 202.

Referring to FIG. 3 which illustrates a roll estimation method 300 on a radar coordinate system according to an exemplary aspect of the present invention. The roll estimation method may be described according to the following exemplary algorithm:
Parameterize roll by the x coordinate of the vector \hat{n} normal to the floor, expressed in camera/radar coordinate system.
Per nₓ hypothesis—construct box 20 cm below floor to 2 m above floor; let p(nₓ) be the percent of points inside this box (discard points closer than 5 m).
Find hypothesis for which p(nₓ) was maximal, take 70% the peak value as threshold, and extract all nₓ values which exceeded this threshold (darker columns).
Estimate \hat{n}ₓ as the average of extracted nₓ values, with p(nₓ) as weights.

The algorithm disclosed above is exemplary in nature and should not limit the scope of the invention. In particular, although the algorithm disclosed above describes an example in which roll angle is determine by counting reflections inside boxes in the x-z plane, it will be appreciated that, where required, equivalent embodiments may determine pitch angle by counting reflections inside boxes in the y-z plane.

The tilt angle of the vehicle at different instances of time may be calculated and stored in the database 118.

It is noted that one use for knowing the tilt angle of the vehicle, may be to allow the frame of reference of vehicle mounted sensors to be aligned to the real world.

As and when required, the tilt angle of the vehicle 202 and some corresponding notification may further be sent to the concerned parties 124a, 124b and 124c. The concerned party 124a may include the rider 204 itself to whom a danger notification is sent when the motorcycle 202 tilt angle reaches or crosses a safe threshold value. The notification may be provided in audio/visual form to alert the rider 204. The notification may also be transmitted to the traffic or road safety police 124b of dangerous driving by the rider 204 when the tilt angle reaches or crosses a safe threshold value. In addition, the tilt angle may also indicate to the police or concerned authorities 124b about the tilt angle of the road to take appropriate actions. The notification may also be sent on the mobile device of the parent or guardians 124c of the rider 204 about the dangerous driving habits of the rider 204.

The tilt angle of the vehicle 202 and the corresponding notifications are sent from the database 118 through the communicator 120 which transmits the information through a communication network 122. The communication network 122 may include Internet, a Bluetooth network, a Wired LAN, a Wireless LAN, a WiFi Network, a Zigbee Network, a Z-Wave Network or an Ethernet Network.

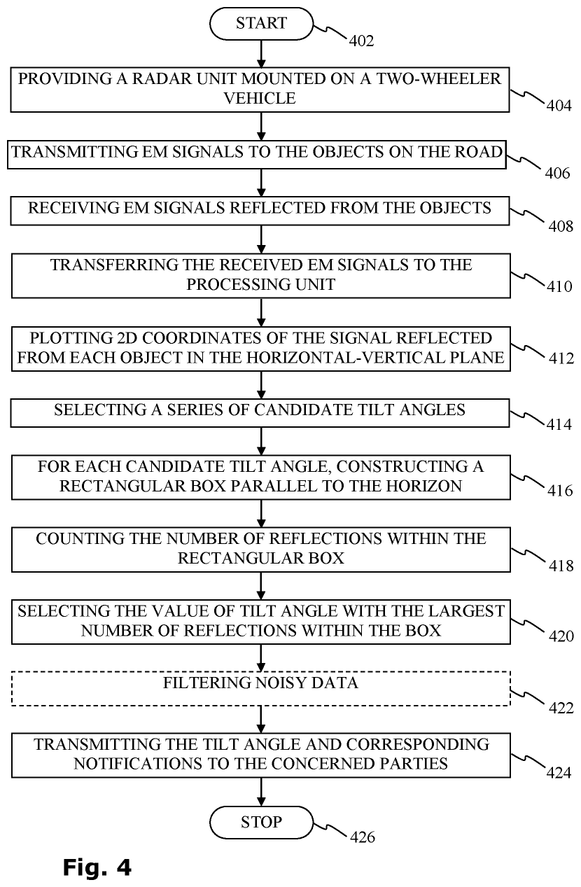

Referring to FIG. 4 which illustrates a flowchart 400 showing method steps for measuring the tilt angle of the motorcycle 202 according to an aspect of the invention. The process starts at step 402 and a radar unit 104 is provided mounted on a two-wheeler vehicle like the motorcycle 202 at step 404. At step 406, the EM signals from the transmitting antennas 106 of the radar unit 104 are transmitted to the objects 102a, 102b, 102c and 102d on the road 102 on which the motorcycle 202 is being driven. The signals reflected from the objects 102a, 102b, 102c and 102d are received by the receiver antennas 110 at step 408. The information received by the receiver 110 may include a horizontal coordinate (perpendicular to the direction of travel or the vehicle) and a vertical coordinate for each object detected. The information may also include motion characteristics of the objects 102a, 102b, 102c and 102d like the stationary and non-stationary state of the object including its state of walking, running, velocity, acceleration, etc.

At step 410, the horizontal and vertical coordinates along with the motion characteristics of the objects 102a, 102b, 102c and 102d are sent to the processing unit 116. At step 412, the processing unit 116 plots a two-dimensional coordinate of each reflected object 102a, 102b, 102c and 102d in the horizontal-vertical plane perpendicular to the direction of motion of the vehicle 202. At step 414, a series of candidate tilt angles 604a, 604b and 604c are selected by the processing unit 116 and for each candidate tilt angle a corresponding rectangular box 602a, 602b and 602c is constructed at step 416. At step 418, The number of reflections plotted inside the rectangular boxes 602a, 602b and 602c are counted and the tilt angle having the maximum number of plotted points inside the box is selected as the tilt angle of the vehicle 202 at step 420.

The term “plot”, “plotted points” etc. may refer to a collection of 2D coordinates of points, or to a 2D representation of reflectivity values versus the coordinates, irrespective of whether this collection of data is displayed by graphical means or not.

It is noted that the data generated by the system may be corrupted with statistical noise. Accordingly, the tilt angle may be estimated to lie only within a relatively high tolerance range. In order to increase the accuracy of the estimated tilt angle, where required, a filter, such a Kalman filter or the like, may be applied to the noisy data at step 422.

At step 424, the tilt angle of the vehicle 202 and some corresponding notification may be sent to the concerned parties 124a, 124b and 124c. The process completes at step 426.

The systems and methods explained above may estimate the tilt angle of the driven two-wheeler vehicle in an efficient and accurate manner.

Further requirements for a tilt estimation system include, the “auto-calibration” procedure estimating the orientation of the radar relative to the direction of movement of the motorcycle's front and issue a warning if the estimated deviation is larger than a certain threshold. Preferably there should be a threshold accuracy of the order of one degree without redress to any specific setup or special handling by the rider.

It is noted that most of the reflections in a typical arena come from the static background (“clutter”). The richest data exists right after the imaging phase and peaks-extraction, including the Doppler-map of the arena, and most promising to be statistically meaningful. The ego-speed of the motorcycle can be obtained from odometry-data such as described in the applicants co-pending international application PCT/IB2020/060508 which is incorporated herein by reference in its entirety.

Nevertheless, the data passed to the application-layer may be slim (tracked targets). The speed data (vₓ, v_{y}) passes estimation through a filter, thus may be less accurate.

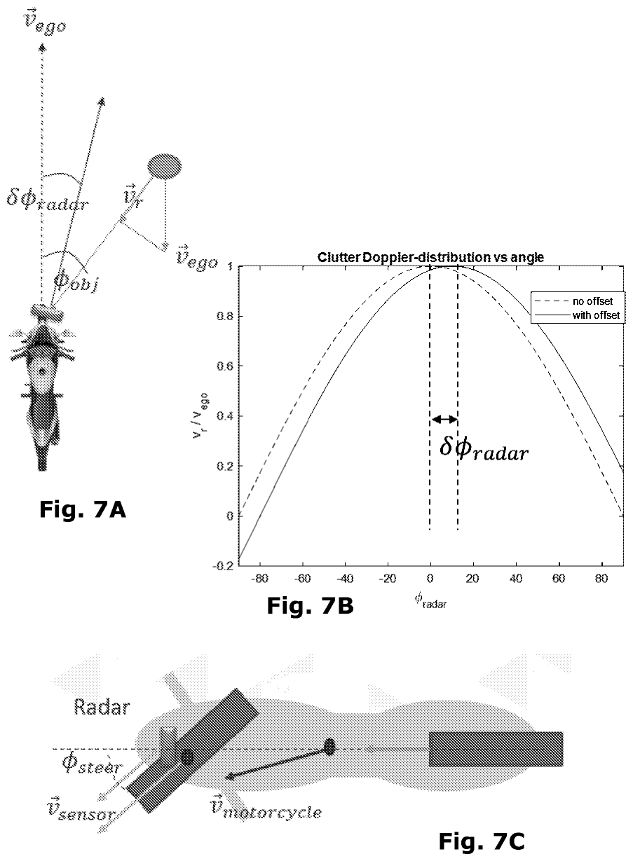

Referring to FIG. 7A, the orientation error δϕ_{radar} may be found, assuming that the self-speed v_{ego} is known.

For the static objects at angle ο_{obj} from the motorcycle's direction of ride, the radial velocity (measured by Doppler-processing) towards the sensor is given by:

$${v}_{r} = - {v}_{ego} \cdot cos ( {ϕ}_{obj} )$$

So, for most reflections in a typical arena (i.e. clutter), the distribution of the radial-velocity (Doppler) against angle from motorcycle's main axis is as above.

The clutter Doppler distribution profile is shown in FIG. 7B. It is noted that looking at the distribution of radial-velocities in the radar's coordinate-system (angle against radar's boresight) the distribution will have an offset proportional to the orientation-error.

This method may be further extended to incorporate also the angle vs the vertical axis (which somewhat resembles “elevation”)

$${v}_{r} = - {v}_{ego} \cdot cos ( {ϕ}_{obj} ) \cdot cos ( {θ}_{obj} )$$

The above described method may work well for a straight ride. However, as illustrated in FIG. 7C, in a motorcycle the front wheel and the radar are not strictly-connected, there is a misalignment between the direction of the motorcycle's front point and radar's boresight, resulting in ambiguity between legitimate steering and radar-misalignment. Accordingly, the steering angle per frame or other such filtering method is required. Notably, motorcycles can impose significant roll-angle variation, which needs to be compensated out.

One potential filtering methods may account for the steering angle, when it is available, to compensate the temporary angle, by:

$${δϕ}_{radar}^{( fix )} = {δϕ}_{radar} - {ϕ}_{steer}$$

In addition—the frames with large ϕₛₜₑₑᵣ may be weighted out of the analysis.

Additionally or alternatively, in another potential filter the motorcycle roll angle can be estimated by the method described above. Accordingly, the roll angle can be used to screen for straight-driving frames (as stable driving on a straight-line corresponds with no roll-angle).

Overall, the radar offset δϕ_{radar} can be estimated by:
Obtaining or estimating the self velocity v_{ego}
Filtering the relevant frames based on steering-angle or roll-angle.
Finding the points\peaks correlating to the static-clutter, for example by matching to the targets-model of velocities distribution over angle and the self-velocity v_{ego} (e.g. by RANSAC)
Matching the points\peaks above to the most occurring distribution of velocities over angle from boresight and over a known or estimated v_{ego}, matched to the static-clutter model.
Comparing the deviation of the distribution in frame n with an even distribution around boresight, to extract δϕ_{radar}[n].
Storing the variance (σ_{ϕ}[n]).
Aggregating δϕ_{radar}[n] over multiple valid frames, and
Estimating over long time by averaging.

It is noted that averaging may be based on a simple average:

$$( {δϕ}_{radar} = \frac{1}{N} {\sum }_{n} δ {ϕ}_{radar} [ n ] ) ,$$

or a weighted average:

$$( δ {ϕ}_{radar} = {\sum }_{m} {σ}_{ϕ} [ m ] \cdot {\sum }_{n} \frac{1}{{σ}_{ϕ} [ n ]} δ {ϕ}_{radar} [ n ] )$$

or any other method (e.g. MLE) as required.

Further methods may include methods for sufficient differentiation in which the self-calibration mechanism works only at certain minimal speed v_{ego,min}, considered vs the radar's Doppler-resolution dv_{ego}, to have enough velocity-bins on the vᵣ(ϕ_{radar}) curve.

It is further noted that the radar-based roll estimation may suffer from installation errors. Once having an external measurement (steering angle or roll-angle from IMU) the roll-angle output can be compared to this data and averaged over long time, to find consistent errors.

Other aspects of the present disclosure relate to systems and methods for providing sensory indications to drivers regarding detected objects surrounding their vehicles and alerting them to potential hazards without distracting them from their driving. In particular audio signals maybe provided to indicate the direction and nature of surrounding objects.

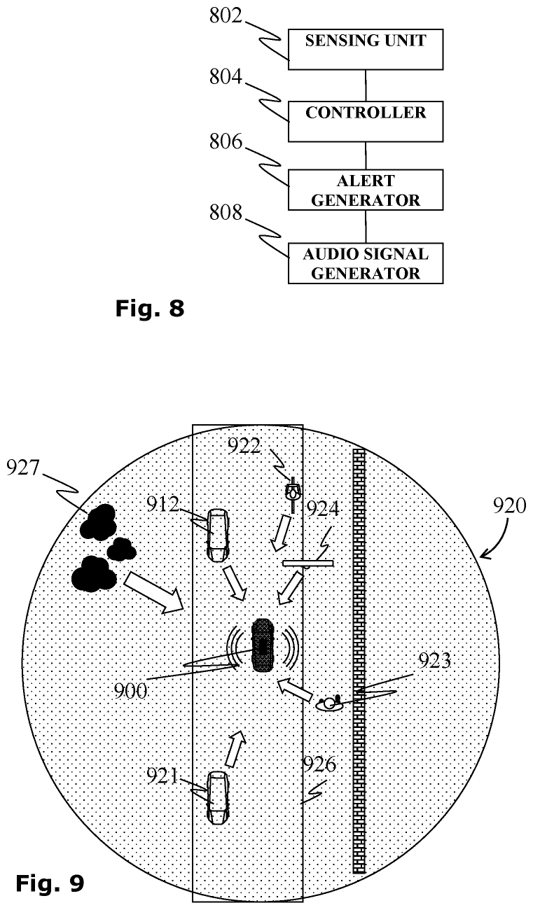

As shown in the block diagram of FIG. 8, the system may include a sensing unit 802, a controller 804, an alert generator 806, and a directional audio signal generation unit 808.

The sensing unit may be a radar unit, a lidar unit, a sonar unit, an echolocating unit, an optical image generator or the like as well as combinations thereof. The sensing unit is configured and operable to collect raw data indicative of the presence of objects within the vicinity of the listener. The raw data may also provide information regarding the relative direction of the objects from the listener. In some embodiments the sensing unit may comprise an array of sensors of a variety of modalities, and/or sensors distributed around the vehicle.

The controller, such as a computing device, may be configured to receive the data from the sensing unit and to execute an identification function thereby ascertaining the direction of detected objects. Where appropriate, the controller may be further operable to identify the nature of the object detected and to communicate control signals to the alert generator. In some embodiments, the controller may include an IMU (inertial measurement unit) or an odometric unit operable to gather data such as velocity and direction from a host vehicle.

The alert generator may be in communication with the controller and operable to receive signals from the controller. The alert generator may be further operable to select alert signal appropriate to the identity and direction of the detected object.

The audio signal generation unit is configured to produce sounds such that a listener perceives the source of the sound as originated from the direction of the detected object. By way of example, the audio signal generation unit may be an array of speakers, for example a pair of stereo speakers, a set of four quadrophonic, earphones or the like.

Reference is now made to FIG. 9 which schematically represents an example of a sensing unit 900 configured to sense objects in the region 920 surrounding a vehicle to which it is mounted. The sensing unit 900 may be mounted to various vehicles as required, such as road vehicles for example cars, trucks, bikes, trailers, caravans and the like, work vehicles such as diggers, cranes, and the like, as well aircrafts and watercrafts where appropriate.

In other systems such a sensing units may be stationary and configured to detect objects entering a surrounding monitored region.

Examples of the sensing unit 900 may be mounted to a car and used to detect various objects in its vicinity such as other cars 921, bicycles 922, pedestrians 923, road signs 924, walls 925, curbs 926, trees 927 and the like.

Accordingly, the sensing unit 900 may be used to harvest information regarding the environment through which the vehicle is travelling. This disclosure teaches various techniques by which a radar unit may analyze received data such that useful information may be gathered such as the vehicles relative speed and the identification of hazards in its surroundings.

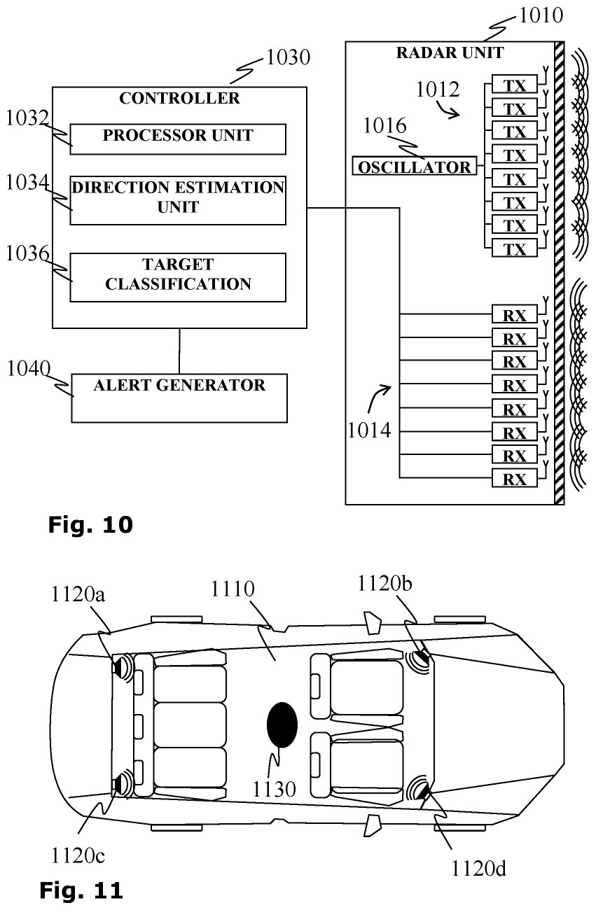

Referring now to the block diagram of FIG. 10 selected elements are presented of a possible radar system which may be provided for sensing the surroundings. The system includes a radar unit 1010 and a controller 1030. The radar unit 1010 may include a radar transmission unit 1012 and a radar receiving unit 1014.

The radar transmission unit 1012 includes an array of transmitter antennas TX connected to an oscillator 1016 and configured to transmit electromagnetic waves into a region surrounding the vehicle. The radar receiving unit 1014 includes at least one receiver antenna RX configured to receive electromagnetic waves reflected by objects within the region surrounding the vehicle 1020 and may be operable to generate raw data.

The controller 130 may include various modules such as processor units 1032, direction estimation units 1034, target classification unit 1036 and the like.

A processor unit 1032 may be in communication with the radar receiving unit 1014 so as to receive raw data from the radar unit 1014 and generate environmental information based upon the received data. For example, a self-velocity calculation module 1034 may be provided to calculate velocity of the vehicle from raw data, a wall detection module 1036 may be provided to detect planar surfaces in the region surrounding the vehicle, a dynamic-range enhancement module 1038 may be provided to distinguish objects reflecting weakly such as pedestrians 1023 from objects reflecting strongly such as a wall 1025 or a curb 1026 within the same vicinity.

The direction estimation module 1034 may determine the direction towards detected targets and the target classification module 1036 may be operable to identify the nature of the detected target.

The controller may provide data to the alert generator 1040 which is provided to select alert signal appropriate to the identity and direction of the detected object.

The radar typically includes at least one array of radio frequency transmitter antennas and at least one array of radio frequency receiver antennas. The radio frequency transmitter antennas are connected to an oscillator (radio frequency signal source) and are configured and operable to transmit electromagnetic waves towards the target region. The radio frequency receiver antennas are configured to receive electromagnetic waves reflected back from objects within the target region.

Accordingly, the transmitter may be configured to produce a beam of electromagnetic radiation, such as microwave radiation or the like, directed towards a monitored region such as an enclosed room or the like. The receiver may include at least one receiving antenna or array of receiver antennas configured and operable to receive electromagnetic waves reflected by objects within the monitored region.

The raw data generated by the receivers is typically a set of magnitude and phase measurements corresponding to the waves scattered back from the objects in front of the array. Spatial reconstruction processing is applied to the measurements to reconstruct the amplitude (scattering strength) at the three-dimensional coordinates of interest within the target region. Thus, each three-dimensional section of the volume within the target region may represented by a voxel defined by four values corresponding to an x-coordinate, a y-coordinate, a z-coordinate, and an amplitude value.

Typically, the receivers are connected to a pre-processing unit configured and operable to process the amplitude matrix of raw data generated by the receivers and produce a filtered point cloud suitable for model optimization.

Accordingly, where appropriate, a preprocessing unit may include an amplitude filter operable to select voxels having amplitude above a required threshold and a voxel selector operable to reduce the number of voxels in the filtered data, for example by sampling the data or clustering neighboring voxels. In this manner, the filtered point cloud may be output to a processor. It is noted that the filtered point cloud may be further simplified by setting the amplitude value of each voxel to ONE when the amplitude is above the threshold and to ZERO when the amplitude is below the threshold.

Reference is now made to FIG. 11, which shows an example of a vehicle cabin 1110 within which a set of audio signal generators 1120a, 1120b, 1120c, 1120d are provided to generate audio signals such that they may be perceived by the driver of the vehicle as originated from the direction of an object detected by a vehicle mounted sensing unit 1130. In other examples, such directional audio signal generators may be provided within a helmet worn by a motorist, a cyclist or motorcyclist for example.

In further embodiments, the sound may be augmented to provide further information to the listener, for example volume may be modulated to indicate proximity to the object and the pitch may be altered to simulate doppler shift thereby indicating the object's relative velocity.

Optionally, the audio signal characteristics may be in correlation to one or more characteristics of the object detected. For example, amplitude, pitch, amplitude modulation, frequency modulation, pulsing of audio signal, timbre or multitone content of the signal may be in correlation with size of the object, distance to it, its velocity, relative velocity, direction of movement, or a measure of hazard presented by the object.

Similarly the nature of the alert sound may also indicate the classification of the target characteristics, for instance—air horn for trucks, car horn, bicycle bell, low pitch human voice for an adult and high pitch for children.

In other embodiments, the audio output may be incorporated into a headset or earphones incorporating a head rotation monitor operable to measure the angle of the head such that perceived direction of the generated sound may be adjusted accordingly.

It is noted that where appropriate the sensing unit may itself be incorporated into the headset or the earphones, for example into a helmet worn by a motorcyclist or the like.

In still other embodiments, tactile feedback may be provided indicating the direction of the detected objects. For example, vibrations in the seats or from the steering wheel may be generated as required. By way of example, vibration of the steering wheel at the left-hand location vs. right hand location may indicate the direction, while characteristics such as magnitude or frequency of vibration may be in correlation to one or more characteristics of the object detected.

It is appreciated that certain features of the invention, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the invention has been described in conjunction with specific embodiments thereof, it is evident that other alternatives, modifications, variations and equivalents will be apparent to those skilled in the art. Accordingly, it is intended to embrace all such alternatives, modifications, variations and equivalents that fall within the spirit of the invention and the broad scope of the appended claims. Additionally, the various embodiments set forth hereinabove are described in terms of exemplary block diagrams, flow charts and other illustrations. As will be apparent to those of ordinary skill in the art, the illustrated embodiments and their various alternatives may be implemented without confinement to the illustrated examples. For example, a block diagram and the accompanying description should not be construed as mandating a particular architecture, layout or configuration.

1. A method for determining the angle of a moving object:
providing a vehicle mounted radar unit comprising a radar transmission unit comprising an array of transmitter antennas connected to an oscillator, and a radar receiving unit comprising at least one receiver antenna;
providing a processing unit in communication with the radar receiving unit;
transmitting electromagnetic radiation into the region surrounding the vehicle;
receiving electromagnetic radiation reflected from objects in the region surrounding the vehicle;
transferring received electromagnetic signals to the processing unit;
plotting the two-dimensional coordinates of each reflected object in the horizontal-vertical plane perpendicular to the direction of motion of the vehicle;
selecting a series of candidate angles;
for each candidate angle,
constructing a virtual box parallel to an associated candidate horizon, and
counting reflections within the virtual box;
selecting the candidate angle with largest number of reflections within the virtual box.

2. The method of claim 1 further comprising filtering noisy data.

3. The method of claim 1 further comprising transmitting angle to concerned parties.

4. The method of claim 1 further comprising estimating the orientation of the vehicle mounted radar unit relative to the direction of movement of the vehicle.

5. The method of claim 4 further comprising issuing a warning if estimated orientation deviates from a required orientation.

7. The method of claim 1 wherein the virtual box comprises a rectangular box.

8. The method of claim 1 wherein the step of constructing a virtual box parallel to an associated candidate horizon comprises constructing a box extending from 20 centimeters below candidate ground level to 2 meters above candidate ground level.

9. The method of claim 1 further comprising storing selected angle in a database.

10. The method of claim 1 further aligning objects detected around the vehicle to the angle.

11. The method of claim 1 further comprising calculating an orientation error between direction of motion of the vehicle and boresight direction of the vehicle mounted radar.

12. The method of claim 11 wherein the step of calculating orientation error comprises:
detecting objects surrounding vehicle;
obtaining or estimating the self velocity v_{ego} of the vehicle;
calculating expected apparent speed of objects detected surrounding the vehicle;
plotting a first distribution over angle of expected apparent speeds of objects detected surrounding the vehicle given the known self-velocity;
plotting a second distribution over angle of measured apparent speeds of objects detected surrounding the vehicle; and
calculating offset of first distribution from second distribution.

13. The method of claim 12 wherein the step of calculating expected apparent speed of objects of objects detected surrounding the vehicle given the known self-velocity comprises calculating vᵣ=−v_{ego}·cos(ϕ_{obj}) for each object.

14. The method of claim 12 wherein the step of calculating expected apparent speed of objects of objects detected surrounding the vehicle given the known self-velocity comprises calculating vᵣ=−v_{ego}·cos(ϕ_{obj})·cos(θ_{obj}) for each object.

15. (canceled)

16. The system of claim 19 further comprising an audio signal generator configured and operable to produce sounds in response to objects detected by the vehicle mounted radar unit such that a listener perceives the sounds as originating at a direction corresponding to a direction in which the object was detected.

17. The system of claim 16 wherein the audio signal generation unit is selected from a group consisting of an array of speakers, a pair of stereo speakers, a set of four quadrophonic, earphones and combinations thereof.

18. The system of claim 16 wherein the audio signal generation unit is provided within a safety helmet worn by a motorist.

19. A system for sensing the surroundings of a vehicle comprising:
a vehicle mounted radar unit comprising:
a radar transmission unit comprising an array of transmitter antennas connected to an oscillator and configured to transmit electromagnetic waves into a region surrounding the vehicle, and
a radar receiving unit comprising at least one receiver antenna configured to receive electromagnetic waves reflected by objects within the region surrounding the vehicle and operable to generate raw data;
a processor unit in communication with the radar receiving unit and configured to receive raw data from the radar unit and operable to generate environmental information based upon the received data;
wherein the processor comprises:
a self-velocity calculation module operable to calculate velocity of the vehicle from raw data; and
a tilt detection module operable to calculate tilt angle of the vehicle, and wherein the tilt detection module comprises a processing unit, and a memory unit storing executable code directed towards calculating energy-profile within a virtual box.

20. The system of claim 19 wherein the self-velocity calculation module comprises an image generation unit, a memory unit, wherein the image generation unit configured and operable to construct a constructing a three dimensional image representing the region surrounding the vehicle comprising a matrix of voxels, each voxel characterized by a set of voxel parameters including:
a horizontal spatial coordinate, x, of a reflecting object along an axis parallel to the path of the vehicle;
a vertical spatial coordinate, y, of the reflecting object along a vertical axis orthogonal to the path of the vehicle;
a radial spatial coordinate, R, of the reflecting object along an axis diverging radially from the vehicle;
an intensity value; and
a Doppler-shift value indicating an apparent radial velocity v_{R} of the reflecting object.
